(19) United States
(12) Patent Application Publication
(10) Pub. No.: US 2013/0262183 A1
(43) Pub. Date: Oct. 3, 2013

(54) METHODS AND APPARATUS TO DISTINGUISH BETWEEN MEDIA PURCHASES AND MEDIA CONSUMPTION

(71) Applicant: Daniel J. Nelson, JR., Tampa, FL (US)

(72) Inventor: Daniel J. Nelson, JR., Tampa, FL (US)

(21) Appl. No.: 13/431,083

(22) Filed: Mar. 27, 2012

(51) Int. Cl. G06Q 30/02

(52) U.S. Cl. 705/7.32; 705/7.29

(57) ABSTRACT

Methods and apparatus are disclosed to distinguish between media purchases and media consumption. An example method includes parsing an electronic mail (e-mail) message for nomenclature associated with media, in response to identifying nomenclature associated with media, parsing the e-mail message for an indication of consumption activity, determining a merchant identity associated with the indication of consumption activity, and selecting a consumption confidence weight for the media based on the indication of consumption activity and the merchant identity.

### FIELD OF THE DISCLOSURE

This disclosure relates generally to on-line media transactions, and, more particularly, to methods and apparatus to distinguish between media purchases and media consumption.

### BACKGROUND

In recent years, merchants have broken out of traditional consumer methods of communication, such as newspaper advertising, television advertising, mass mailings and/or radio advertising. Communication techniques employed by merchants related to products and/or services now include computer-based electronic mail (e-mail) and/or web-based communication techniques. Information from merchants to consumers may occur via household computing devices (e.g., personal computers) as well as mobile devices (e.g., telephones and iPods®) and/or tablets (e.g., iPads®) having web and/or e-mail capabilities.

### BRIEF DESCRIPTION OF THE DRAWINGS

FIG. 1 is a schematic illustration of an example electronic mail monitor constructed in accordance with the teachings of this disclosure to distinguish between media purchases and media consumption.

FIGS. 2A and 2B are example portions of e-mail messages analyzed by the example electronic mail monitor of FIG. 1.

FIG. 3 is an example table generated by the example electronic mail monitor of FIG. 1.

FIGS. 4 and 5 are flowcharts representative of example machine readable instructions which may be executed to distinguish between media purchases and media consumption.

FIG. 6 is a block diagram of an example system that may execute the example machine readable instructions of FIGS. 4 and 5 to implement the example electronic mail monitor of FIG. 1 and/or to generate the example table of FIG. 3.

### DETAILED DESCRIPTION

Methods and apparatus are disclosed to distinguish between media purchases and media consumption. An example method includes parsing an electronic mail (e-mail) message for nomenclature associated with media, in response to identifying nomenclature associated with media, parsing the e-mail message for an indication of consumption activity, determining a merchant identity associated with the indication of consumption activity, and selecting a consumption confidence weight for the media based on the indication of consumption activity and the merchant identity.

Transactions between merchants and consumers may include an e-mail message to the consumer to confirm the transaction. For example, a consumer that has just used a credit card to pay for an item may receive an electronic mail (e-mail) message from the credit card company indicating that the credit card has just been used. Additionally, the e-mail message may include details related to the transaction such as, but not limited to, a merchant name, a merchant address, a transaction date and/or time, and/or a transaction amount. In some examples, a merchant may e-mail a receipt of one or more transactions with the consumer instead of and/or in addition to a paper receipt. The e-mail receipt may also include warranty information, rebate information, customer service information and/or information related to other merchant location(s).

Methods, apparatus, systems and/or articles of manufacture disclosed herein distinguish between media purchases and media consumption activity associated with consumers. In some examples, e-mail messages sent by a merchant are examined to identify a merchant name, a transaction date, item description(s) and/or corresponding prices associated with purchased goods and/or services. Additionally, methods, apparatus, systems and/or articles of manufacture disclosed herein identify media purchased, streamed, downloaded and/or rented in a manner that identifies an indication of media consumption activity.

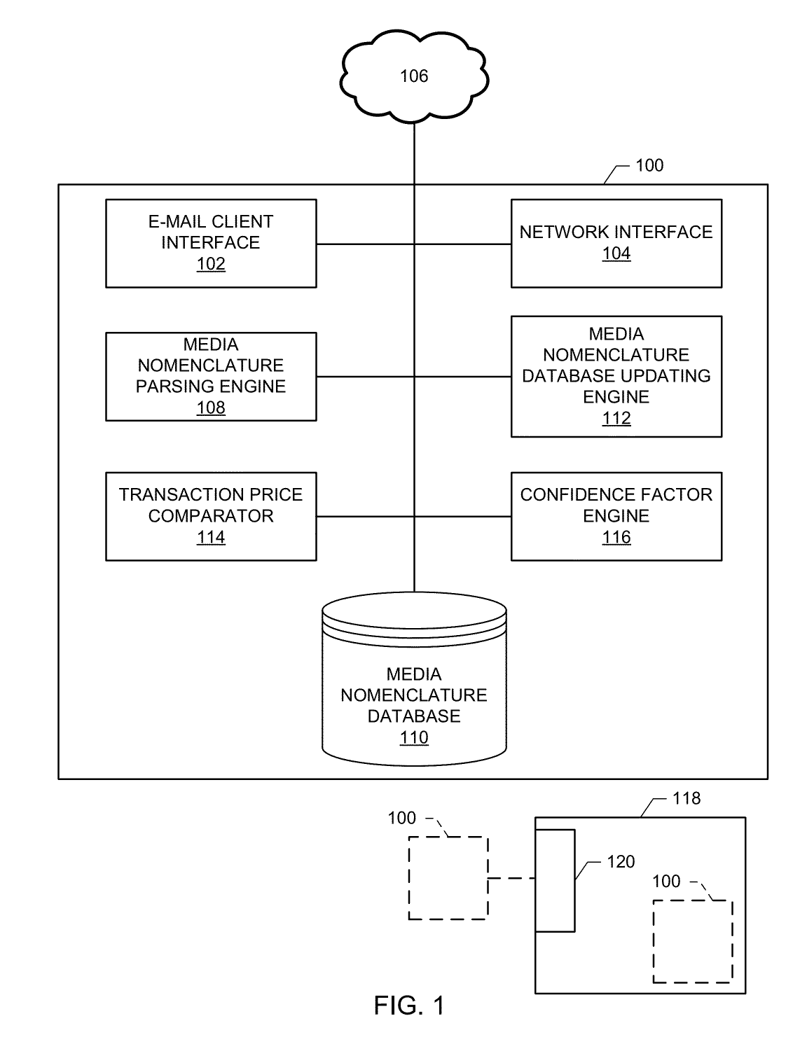

FIG. 1 is a schematic illustration of an example media e-mail monitor 100 to distinguish between media purchases and media consumption. In the illustrated example of FIG. 1, the media e-mail monitor 100 includes an e-mail client interface 102, and a network interface 104 communicatively connected to a network 106, such as the Internet and/or one or more intranets. The example e-mail monitor 100 also includes a media nomenclature parsing engine 108, a media nomenclature database 110, a media nomenclature database updating engine 112, a transaction price comparator 114, and a confidence factor engine 116. In operation, the example media e-mail monitor 100 may execute as software or hardware on a computing device 118 and/or the example media e-mail monitor 100 may be connected to the computing device 118 via a port 120, such as a serial port, a universal serial bus port, a firewire port, etc. The example computing device 118 may include, but is not limited to a personal computer (PC), a mobile telephone (e.g., an Android® phone, an iPhone®, a Blackberry®, etc.), a tablet (e.g., an iPad), a laptop, a set-top box and/or a netbook computer.

The example e-mail client interface 102 monitors one or more e-mail application(s) associated with the example computing device 118, such as Microsoft Outlook®. In other examples, the e-mail client interface 102 monitors one or more web-browsers executing on the computing device 118 to identify a web-based e-mail service, such as Yahoo® Mail, Gmail®, Hotmail®, etc. For example, the e-mail client interface 102 may identify a known uniform resource identifier (URI), such as www.gmail.com, or a portion thereof, such as “gmail” or “gmail.com.” In response to identifying the known URI and/or an e-mail window associated with Microsoft Outlook®, the example media nomenclature parsing engine 108 scans the e-mail message for nomenclature associated with media. Media nomenclature may include, but is not limited to movie title names, broadcast television names and/or documentary names. Example manners of identifying URIs are disclosed, for example, in Coffey, U.S. Pat. No. 5,675,510.

In some examples, the media nomenclature parsing engine 108 identifies file extension types associated with media such as, but not limited to .mp3 and/or .aac (advanced audio coding) to identify music, and/or .mp4 to identify digital video and/or digital audio streams. Additionally, the example media nomenclature parsing engine 108 may identify nomenclature associated with media by comparing parsed text from the e-mail message with information stored in the example media nomenclature database 110. The example media nomenclature database 110 may store any number of music titles, artist names, album names, movie titles, documentary titles, etc. Additionally, the example media nomenclature parsing engine 108 may update the example media nomenclature database 110 with additional nomenclature (e.g., new movie titles, new artist names, etc.) by invoking the example media nomenclature database updating engine 112 to query one or more external sources via the example network interface 104. For example, the media nomenclature database updating engine may, on a periodic, aperiodic, manual and/or scheduled basis, query the Internet Movie database (IMdB). IMDb Pro® is a service that includes, for example, approximately 80,000 representation listings for actors, directors, and producers.

If nomenclature associated with media is not identified, the example e-mail client interface 102 continues to monitor the example computing device 118 for e-mail activity. On the other hand, in the event the media nomenclature parsing engine 108 identifies nomenclature associated with media (e.g., a movie title, a song title, an album title, an artist name, etc.), the example media nomenclature parsing engine 108 parses and/or otherwise examines the identified e-mail message for keywords and/or phrases associated with activity associated with the media nomenclature. For example, some merchants transmit an e-mail message to a customer in response to one or more transactions and/or events, such as merchandise purchases, media rentals, media streaming requests, media streaming quality surveys, confirmation of media shipment(s) (e.g., DVD deposit with mail and/or delivery service), and/or confirmation of media receipt (e.g., DVD rental/loan receipt at the merchant facility).

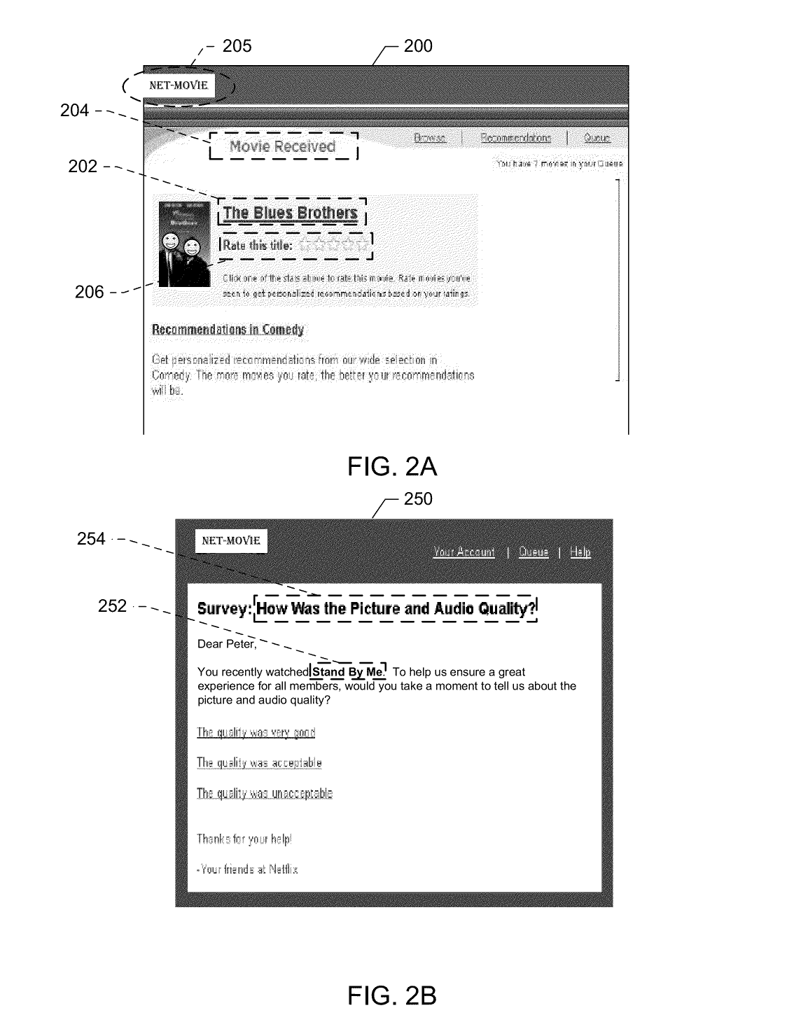

FIG. 2A is an example portion of an e-mail message 200 from a media service (Netflix®) that includes keywords and/or phrases associated with activity associated with media nomenclature. In the illustrated example of FIG. 2A, the e-mail message 200 includes an indication of a movie title 202 (e.g., “The Blues Brothers”) and a first indication of an activity 204 associated with the movie title (e.g., “Movie Received”). The example e-mail message 200 of FIG. 2A represents a media return confirmation message to the consumer. The example media nomenclature parsing engine 108 may identify text and/or images via optical character recognition and compare keywords and/or phrases to contents of the example media nomenclature database 110 to identify one or more matches. Additionally, the example media nomenclature parsing engine 108 may identify an indication of merchant identity 205, such as the example logo “Net-Movie” of FIG. 2A. The example first indication of activity 204 associated with the indication of the movie title 202 in the example of FIG. 2A is the statement “Movie Received,” to which the example confidence factor engine 116 can apply a consumption confidence weight to be associated with the identified movie title, discussed in further detail below.

The example e-mail message 200 of FIG. 2A also includes a second indication of an activity 206 (e.g., “Rate this title: “), which includes selectable icons. The consumer receiving the example e-mail message 200 may choose to select one or more icons so that, for example, the merchant (e.g., Netflix®) can better identify one or more other movie titles, genres, and/or actors that the consumer may either enjoy or dislike. In the event the example media nomenclature parsing engine identifies and/or otherwise detects that the consumer has selected one or more icons of the second indication of activity 206, then the example confidence factor engine may augment the consumption confidence weight associated with the identified movie title. For example, upon receipt of the example e-mail message 200, the second indication of an activity 206 is blank and/or otherwise not populated with one or more selections (e.g., a number of rating “stars”). As such, the example confidence factor engine 116 may apply a first consumption confidence weight based on the first indication of activity 204. However, when the example media nomenclature parsing engine 108 detects that the consumer selects one or more icons associated with the second indication of activity 206 (e.g., selecting all five rating “stars” to indicate a strong preference for the movie “The Blues Brothers”), then the example confidence factor engine 116 may apply a second consumption confidence weight that is greater than the first consumption confidence weight.

FIG. 2B is an example portion of an e-mail message 250 from an example media service (e.g., Netflix) that includes an indication of a movie title 252 (e.g., “Stand By Me”), and includes keywords and/or phrases associated with an indication of an activity 254 (e.g., “How Was the Picture and Audio Quality?”). The example e-mail message 250 represents a quality survey request from the merchant (e.g., a Netflix® merchant). In the illustrated example of FIG. 2B, the indication of activity 254 detected and/or otherwise identified by the media nomenclature parsing engine 108 is evaluated by the confidence factor engine 116 to reveal that streaming activity has occurred with the merchant (e.g., a Netflix® merchant). Additionally, the example confidence factor engine 116 may associate a consumption confidence weight relatively higher than that associated with FIG. 2A because, for example, the merchant only sends such e-mail messages to customers after they detect actual streaming activity for that customer.

In some examples, the media nomenclature parsing engine 108 does not identify keywords and/or phrases indicative of activity associated with an identified media (e.g., an identified movie title, song, etc.). To determine an appropriate consumption confidence weight associated with such media, the example transaction price comparator 114 determines whether the e-mail message includes a transaction amount. A relatively lower transaction amount associated with media may be indicative of a movie rental and/or streaming transaction, while a relatively higher transaction amount associated with media may be indicative of a movie purchase (e.g., physical DVD (digital versatile disc) media). Generally speaking, transactions indicative of rental and/or other relatively short-term rights to media are attributed a relatively greater degree of confidence that consumption of that media has occurred and/or will occur in the near future. Additionally, transactions indicative of rental and/or other relatively short-term rights to media include a degree of urgency on behalf of the consumer, such that consumption must occur prior to the expiration of the rental period and/or expiration of the rights to view and/or stream the media.

On the other hand, transactions indicative of purchase and/or other non-temporal restricted media access rights are attributed a relatively lesser degree of confidence that consumption of that media has occurred and/or will occur in the near future. For example, a relatively higher transaction amount may be associated with the purchase of a DVD, which may not be consumed (e.g., viewed) in the near future, or may be purchased as a gift for someone else. In other examples, a relatively higher transaction amount associated with a media title (e.g., a movie title) near a known gift-giving holiday (e.g., Christmas, Easter, Holi, etc.) may be attributed a relatively lower degree of confidence that consumption of the media will occur in the near future.

Commercial services (e.g., Amazon® instant video) allow consumers to purchase a video for streaming and/or for downloading to a computing device. Streaming videos purchased through such services may be viewed by the consumer on an authorized device (e.g., Internet-connected television, Blu-Ray® player, set-top box, Android® tablet, etc.), and typically require a network connection. Downloaded videos purchased through such services may be viewed by the consumer on one or more similar authorized devices capable of storing the video and, typically, do not require a network connection. Purchased videos and/or other purchased content is typically authorized to be viewed by the consumer for an indefinite period of time, which is generally consistent with ownership of the purchased media.

On the other hand, commercial media providing services such as Amazon® instant video also allow consumers to rent a video for streaming and/or for downloading to the computing device. While the manner of viewing the rented downloaded and/or streamed media is similar to the manner in which purchased media is viewed, the consumer is typically authorized to view the media for only a finite period of time. For example, rental viewing periods may expire 30 days after the date on which the media was rented (e.g., 30 days from the credit card transaction to rent the video). In other examples, a time period of 24 to 48 hours is initiated after the consumer begins to stream the rented media and/or after the consumer downloads the media to an authorized computing device. Upon expiration of the example 24 to 48 time period, the streaming services cease and/or the downloaded video is prevented from being played.

In the event the example transaction price comparator 114 identifies an indication of transaction cost on the e-mail message, a corresponding classification of purchase or rental may be associated with the identified media. For example, if “Blues Brothers” is identified by the example media nomenclature parsing engine 108 when parsing an e-mail message from a media provider (e.g., Amazon®), and a corresponding transaction cost is identified as $3.99, then the example transaction price comparator 114 associates the transaction with media rental activity. Further, because the transaction is deemed to be associated with media rental activity, the example confidence factor engine 116 associates a relatively high consumption confidence weight (e.g., 0.80 on a scale between 0.00 and 0.99). In another example, if “Blues Brothers” is identified by the example media nomenclature parsing engine 108 when parsing the e-mail message from the media provider, and a corresponding transaction cost is identified as $14.99, then the example transaction price comparator 114 associates the transaction with media purchase activity. Further, because the transaction is deemed to be associated with media purchase activity, the example confidence factor engine 116 associates a relatively low consumption confidence weight (e.g., 0.31 on a scale between 0.00 and 0.99). In other words, circumstances associated with physical media purchasing as typically not as likely to be associated with imminent consumption of the identified media because there is less or no urgency to consume the media prior to a temporal deadline.

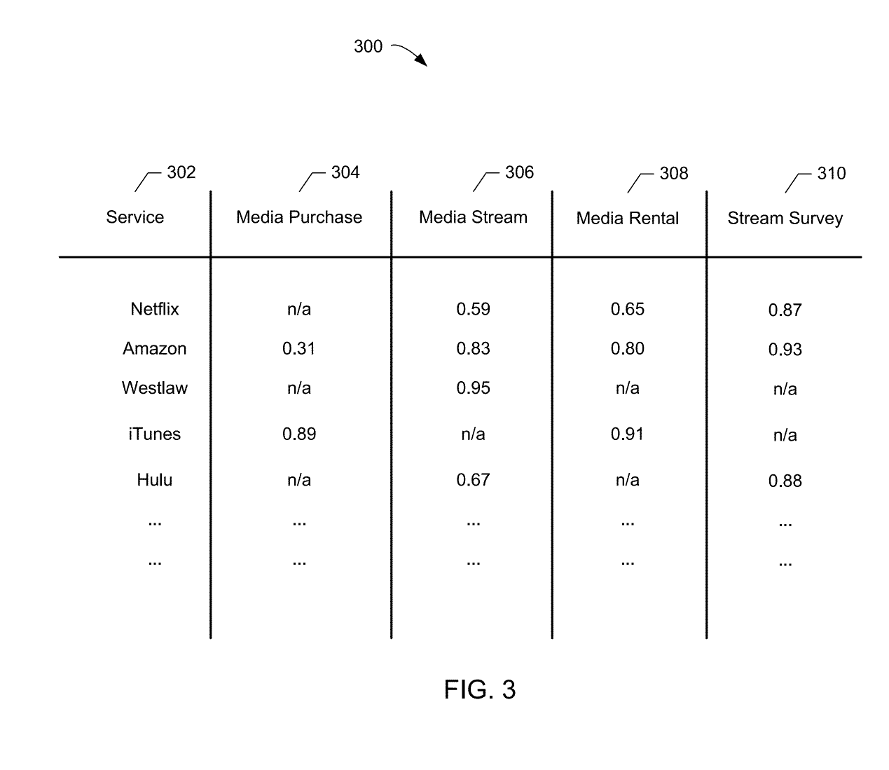

FIG. 3 is an example consumption confidence factor (weight) chart (matrix) 300 to associate media identified by the example media nomenclature parsing engine 108 with a corresponding consumption confidence weight and/or other consumption activity indicator. As described above, the consumption confidence weight associated with each instance of media detected by the parsing engine 108 may be used to attribute an indication of the likelihood that the media was consumed. In some examples, media may be purchased and added to a collection of physical DVDs without immediate consumption. In other examples, streaming activity may begin, but terminate before the completion of the media duration. For instance, Netflix® customers may initiate a media streaming session out of passing curiosity and stop prior to completion of the media program absent concern for financial loss (i.e., Netflix® customers pay a monthly subscription fee that allows unlimited streaming from a collection of media). Amazon customers, on the other hand, may pay for rights to stream a particular piece of media and, as such, be less likely to stop full consumption of the media prior to its end. As such, the example confidence factor engine 116 may attribute a relatively higher consumption confidence weight to Amazon® customers that rent media as compared to the Netflix® customers that stream media.

In the illustrated example of FIG. 3, the confidence factor chart 300 includes a service column 302, a media purchase column 304, a media stream column 306, a media rental column 308, and a stream survey column 310. While the example service column 302 includes specific service merchants (e.g., Netflix®, Amazon®, Westlaw®, iTunes® and Hulu®), any number of additional and/or alternate merchants may be included in the example service column 302. In response to the example media nomenclature parsing engine 108 detecting a merchant, an indication of media and an indication of activity associated with the media, the example confidence factor engine 116 references the example confidence factor chart 300 to identify a corresponding consumption confidence weight to associate with the detected media. For example, if the detected e-mail indicates that the Netflix® merchant streams the media to the customer (e.g., as evidenced by the example e-mail 200 of FIG. 2A), then the example confidence factor engine 116 attributes a consumption confidence weight from the media stream column 306 of 0.59 with the media. In other words, there was a 59% likelihood that the consumer consumed the identified media. In another example, if the detected e-mail indicates that the Amazon® merchant streams the media to the customer, then the example confidence factor engine 116 attributes a consumption confidence weight from the media stream column 306 of 0.83.

While the example confidence factor chart 300 includes the media purchase column 304, the media stream column 306, the media rental column 308 and the stream survey column 310, one or more additional and/or alternate columns indicative of media activity may be employed in the chart 300. For example, while the Netflix® merchant is not currently selling media to customers (“N/A”), one or more future business decisions with the Netflix® merchant may change. In the event of such media selling activity, the not-applicable (N/A) designation in the media purchase column 304 for Netflix® may be replaced with a corresponding consumption confidence weight. Additionally or alternatively, while the example confidence factor chart 300 includes one or more consumption confidence weight values for each merchant and corresponding activity, such consumption confidence weight values may be altered at any time. In some examples, consumption confidence weight values vary based on empirical evidence (e.g., observed trends) associated with one or more merchants. In other examples, consumption confidence weight values vary based on one or more promotions and/or terms-of-service changes initiated by the one or more merchants. In still other examples, consumption confidence weight values vary from one geography to another.

While an example manner of implementing the media e-mail monitor 100 of FIG. 1 has been illustrated in FIGS. 1, 2A, 2B and 3, one or more of the elements, processes, screen-shots and/or devices illustrated in FIGS. 1, 2A, 2B and 3 may be combined, divided, re-arranged, omitted, eliminated and/or implemented in any other way. Further, the example e-mail monitor 100, the example e-mail client interface 102, the example network interface 104, the example media nomenclature parsing engine 108, the example media nomenclature database 110, the example transaction price comparator 114, the example confidence factor engine 116, and/or the example confidence factor chart 300 of FIGS. 1 and 3 may be implemented by hardware, software, firmware and/or any combination of hardware, software and/or firmware. Thus, for example, any of the example e-mail monitor 100, the example e-mail client interface 102, the example network interface 104, the example media nomenclature parsing engine 108, the example media nomenclature database 110, the example transaction price comparator 114, the example confidence factor engine 116, and/or the example confidence factor chart 300 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example, e-mail monitor 100, the example e-mail client interface 102, the example network interface 104, the example media nomenclature parsing engine 108, the example media nomenclature database 110, the example transaction price comparator 114, the example confidence factor engine 116, and/or the example confidence factor chart 300 are hereby expressly defined to include a tangible computer readable medium such as a memory, DVD, CD, Blu-ray, etc. storing the software and/or firmware. Further still, the example e-mail monitor 100 of FIG. 1 and the example confidence factor chart 300 of FIG. 3 may include one or more elements, processes and/or devices in addition to, or instead of, those illustrated in FIGS. 1, 2A, 2B and 3, and/or may include more than one of any or all of the illustrated elements, processes and devices.

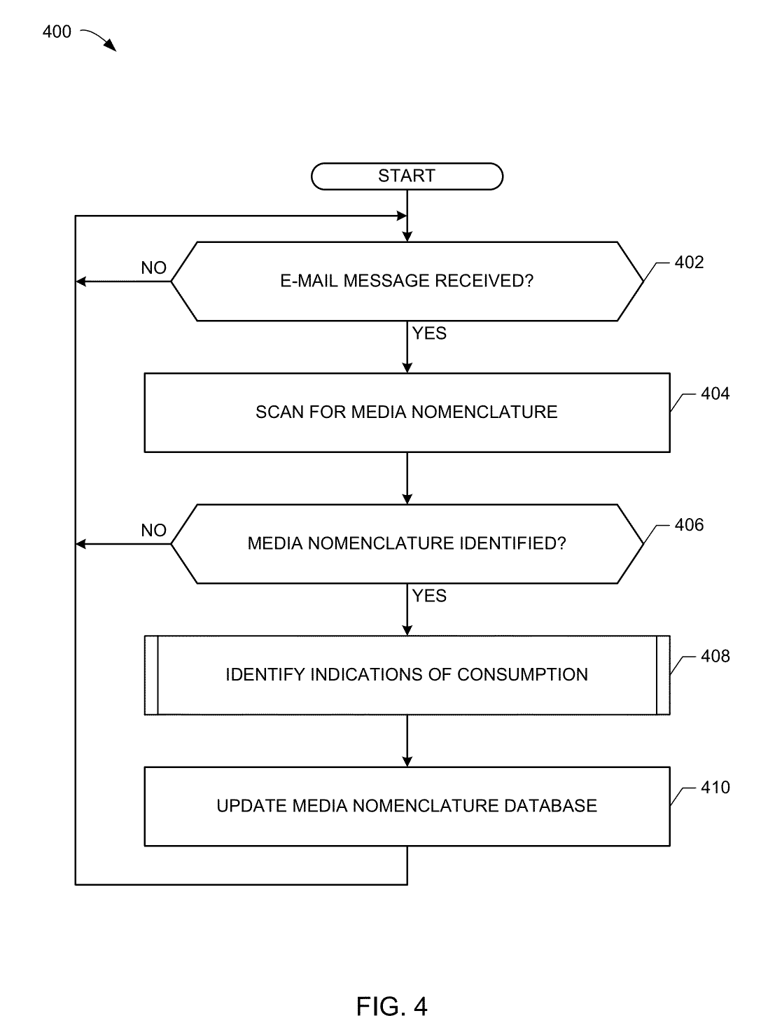

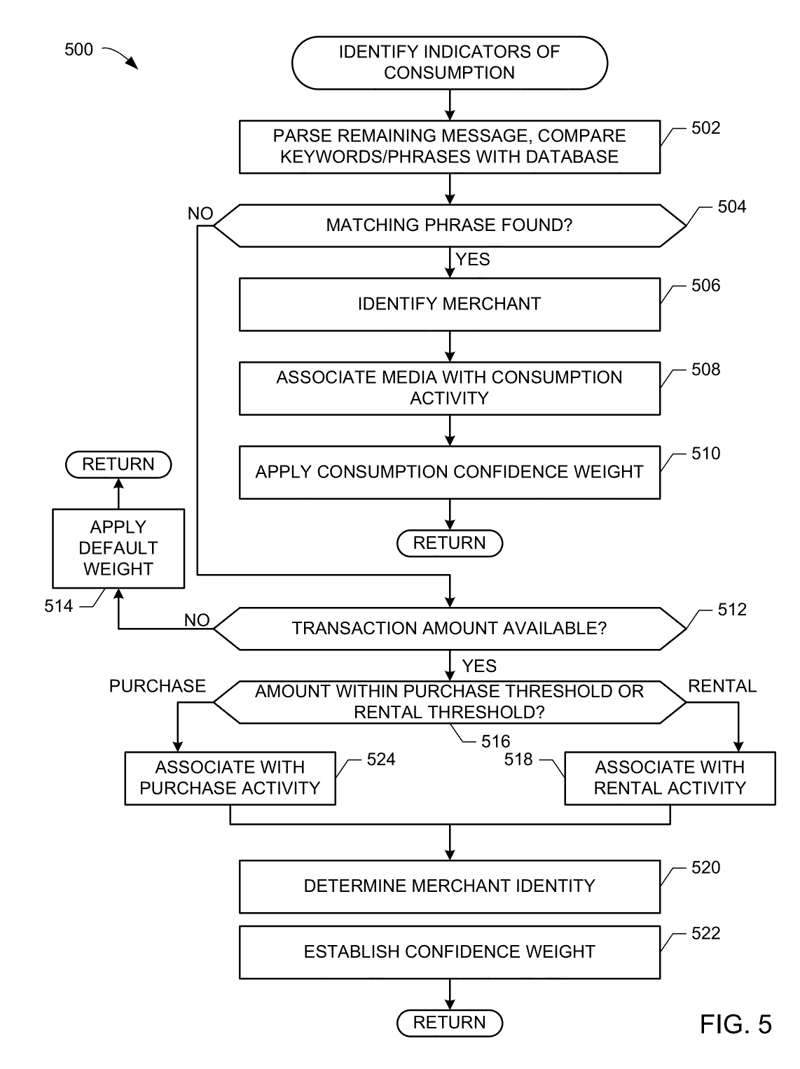

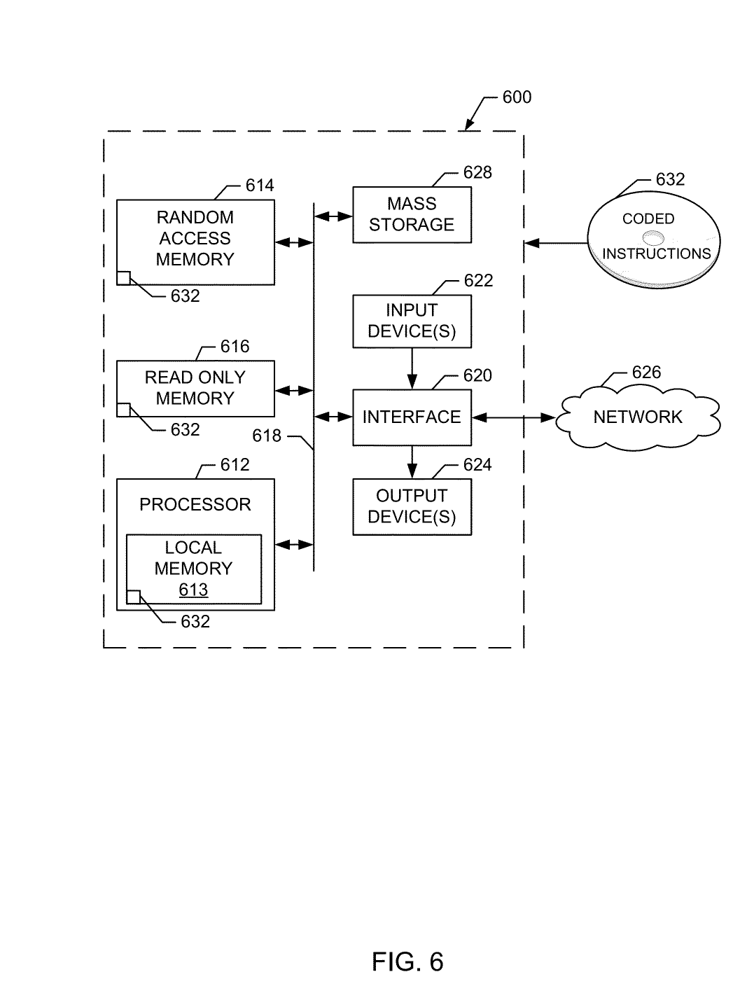

A flowchart representative of example machine readable instructions for implementing the e-mail monitor 100 of FIG. 1 is shown in FIGS. 4 and 5. In this example, the machine readable instructions comprise a program for execution by a processor such as the processor 612 shown in the example computer 600 discussed below in connection with FIG. 6. The program may be embodied in software stored on a tangible computer readable medium such as a CD-ROM, a floppy disk, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example program is described with reference to the flowchart illustrated in FIGS. 4 and 5, many other methods of implementing the example e-mail monitor 100 and/or confidence factor chart 300 may alternatively be used. For example, the order of execution of the blocks may be changed, and/or some of the blocks described may be changed, eliminated, or combined.

As mentioned above, the example processes of FIGS. 4 and 5 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 4 and 5 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The program 400 of FIG. 4 begins at block 402 where the example e-mail client interface 102 monitors one or more e-mail applications associated with the computing device 118 for an e-mail message. If no e-mail message is identified and/or otherwise received at the example computing device 118 (e.g., via Microsoft® Outlook®, via Gmail®, via Yahoo® Mail, etc.), then the example e-mail client interface 102 continues to monitor the computing device 118 (block 402). In the event an e-mail message is detected by the example e-mail client interface 102 (block 402), then the example media nomenclature parsing engine 108 parses the e-mail message for an indication of media nomenclature (block 404). As described above, media nomenclature may include, but is not limited to movie title names, actor names, documentary title names, situational comedy title names, drama title names, concert title names, music title names, and/or artist names. Media nomenclature may be stored in the example media nomenclature database 110 for query and/or comparison by the example media nomenclature parsing engine 108 (block 404).

If media nomenclature is not identified (block 406), such as when text parsed from the e-mail message does not have any corresponding matches in the example media nomenclature database 110, then the program returns to block 402 to monitor for additional instances of received e-mail messages. On the other hand, if media nomenclature is identified (block 406), then the example media nomenclature parsing engine 108, the example transaction price comparator 114 and/or the example confidence factor engine 116 identify one or more indications of media consumption (block 408), as described in further detail below. When the media is associated with a corresponding consumption confidence weight, the example program 400 updates the example media nomenclature database 110 (block 410), and then returns to block 402 to monitor for additional instances of received e-mail messages. As describes above, the example media nomenclature database updating engine 112 may access one or more external sources of media information that may contain additional movie title nomenclature, music titles, artist names, album names, documentary titles, etc. One example external database containing movie titles, actors, directors and producers is the IMDb, as described above.

FIG. 5 illustrates an example program 500 to implement block 408 of FIG. 4 to identify indications of consumption. In the illustrated example of FIG. 5, the example media nomenclature parsing engine 108 parses the remaining portion(s) of the identified e-mail message for keywords and/or phrases associated with media actions (block 502). In the event one or more indications of media action are identified (block 504), such as after one or more queries by the example media nomenclature parsing engine 108 to the example media nomenclature database 110, the corresponding merchant is identified (block 506). As described above, the example media nomenclature database 110 may store text and/or images (e.g., merchant logos) that, when compared to the text and/or images of the retrieved e-mail message, result in identification of one or more merchants (e.g., the indication of merchant identity 205 in FIG. 2A). The media is associated with consumption activity (block 508) and a consumption confidence weight is applied (block 510).

As described above, the consumption confidence weight value may be associated and/or otherwise attributed to the identified media (e.g., a movie title) based on values from the example confidence factor chart 300 of FIG. 3. For example, if the identified media is associated with the merchant iTunes® and an indication of media purchase activity is detected, then the example confidence factor engine 116 attributes the media with a consumption weight of 0.89. In other words, an 89% likelihood exists that the consumer that purchased the identified media has consumed that media and/or will consume that media within a threshold period of time.

In some examples, one or more indications of media activity are absent and/or otherwise not found (block 504). New, additional and/or alternate indications of media activity may be developed by the one or more merchants at any time. As described above, the example media nomenclature database 110 may be updated with new, additional and/or alternate indications of media activity by the example media nomenclature database updating engine 112. For example, some merchants send e-mail messages to their customers having language such as “Please Rate What You Have Just Watched” in response to detecting streaming activity via their services. In other examples, merchants may send e-mail messages to their customers having language such as “We're sorry you have had trouble viewing you selected program. Please provide us with more details of your system so that we may troubleshoot” in response to detecting one or more streaming activity attempts by consumers that resulted in failure. In still other examples, merchants may send e-mail messages to their customers having language such as “We have received your rented move in our dropbox” in response to detecting a rented DVD and/or other media returned to a mailing facility or other return depot. The merchant named Redbox®, for example, allows consumers to rent DVD media on a day-by-day basis via one or more kiosks. When the consumer is finished with the DVD, the Redbox® kiosk may e-mail the consumer with a receipt of the transaction and confirmation that the media has been safely received. Additional example e-mails that may be sent by merchants to customers includes language such as “Please tell us about the video quality of <movie name>.”

In the event that none of the aforementioned media action phrases, or similar, are detected by the example media nomenclature parsing engine 108, then the example transaction price comparator 114 determines whether the received e-mail includes an indication of a transaction amount (block 512). If not, then the example confidence factor engine 116 may apply a default weight (e.g., zero) (block 514). In other examples, the example media nomenclature parsing engine 108 may scan, parse and/or otherwise detect merchant nomenclature on the e-mail message to identify which merchant sent the e-mail. Different merchant names may be associated with different consumption confidence weight values to be attributed to the identified media (block 514).

On the other hand, in the event a transaction amount appears in the e-mail message (block 512), then the example transaction price comparator 114 determines whether the amount is to be associated with purchase activity (e.g., a purchase event) or rental activity (e.g., a media rental event) (block 516). One or more transaction price thresholds may be established by the example transaction price comparator 114 to determine whether a purchase activity or a rental activity is associated with the media identified in the received e-mail message (block 516). For example, if the transaction price is identified to be $4.99 or lower, then the transaction price comparator 114 associates the action with rental activity (block 518), identifies the merchant identity (block 520), and establishes a consumption confidence weight to be associated with the media (block 522) (e.g., by reference to the example confidence factor chart 300 of FIG. 3). If the transaction threshold is greater than, for example, $4.99 (block 516), then the example transaction price comparator 114 associates the action with purchase activity (block 524), identifies the merchant identity (block 520), and establishes a consumption confidence weight to be associated with the media (block 522).

FIG. 6 is a block diagram of an example computer 600 capable of executing the instructions of FIGS. 4 and 5 to implement the media e-mail monitor 100 of FIG. 1. The computer 600 can be, for example, a server, a personal computer, a mobile device (e.g., a cell phone, an iPod®, an iPad®, etc.), a personal digital assistant (PDA), an Internet appliance, an e-mail enabled DVD player, an e-mail enabled digital video recorder, an e-mail enabled Blu-ray player, an e-mail enabled set top box, a tablet (e.g., an iPad®) or any other type of computing device.

The system 600 of the instant example includes a processor 612. For example, the processor 612 can be implemented by one or more microprocessors or controllers from any desired family or manufacturer.

The processor 612 includes a local memory 613 (e.g., a cache) and is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The computer 600 also includes an interface circuit 620. The interface circuit 620 may be implemented by any type of interface standard, such as an Ethernet interface, a universal serial bus (USB), and/or a PCI express interface.

One or more input devices 622 are connected to the interface circuit 620. The input device(s) 622 permit a user to enter data and commands into the processor 612. The input device(s) can be implemented by, for example, a keyboard, a mouse, a touchscreen, a track-pad, a trackball, isopoint and/or a voice recognition system.

One or more output devices 624 are also connected to the interface circuit 620. The output devices 624 can be implemented, for example, by display devices (e.g., a liquid crystal display, a cathode ray tube display (CRT), a printer and/or speakers). The interface circuit 620, thus, typically includes a graphics driver card.

The interface circuit 620 also includes a communication device, such as a modem or network interface card to facilitate exchange of data with external computers via a network 626 (e.g., an Ethernet connection, a digital subscriber line (DSL), a telephone line, coaxial cable, a cellular telephone system, etc.).

The computer 600 also includes one or more mass storage devices 628 for storing software and data. Examples of such mass storage devices 628 include floppy disk drives, hard drive disks, compact disk drives and digital versatile disk (DVD) drives. The mass storage device 628 may implement the media nomenclature database 110.

The coded instructions 632 of FIGS. 4 and 5 may be stored in the mass storage device 628, in the volatile memory 614, in the non-volatile memory 616, and/or on a removable storage medium such as a CD or DVD.

From the foregoing, it will be appreciated that methods, systems, apparatus and articles of manufacture have been disclosed, which allow media researchers to employ a non-invasive manner of media consumption measurement. As e-mail presence, on-line activity and/or mobile device access to e-mail increases, so does merchant participation in such connectivity increase. Increasing numbers of merchants request an e-mail address to allow prompt updates to corresponding consumers based on their transactions with the merchants. Accordingly, the above example disclosed methods, systems, apparatus and articles of manufacture facilitate identifying consumption of media, a degree of confidence associated with whether consumption was likely to have occurred, and a manner of distinguishing between media purchases and activities associated with media consumption. Such methods may be used to supplement and/or adjust ratings based on exposure to media. For example, consumer device(s) in the home of a panelist (e.g., a person who has agreed to be monitored by an audience measurement entity) may be monitored to determine media played on such devices and/or personally exposed to such media, whether such persons actually consumed the media supplied thereto, etc. Methods, apparatus and/or articles of manufacture disclosed herein may be used to determine consumption of such media. This additional data may provide a basis for computing a consumption rating that complements the traditional exposure rating (e.g., audio share ratings provided by Nielsen®) and/or to adjust the translated exposure ratings.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to identify media consumption, comprising:
parsing an electronic mail (e-mail) message for nomenclature associated with media;
in response to identifying nomenclature associated with media, parsing the e-mail message for an indication of consumption activity;
determining a merchant identity associated with the indication of consumption activity; and
selecting a consumption confidence weight for the media based on the indication of consumption activity and the merchant identity.

2. A method as described in claim 1, further comprising searching for an indication of media streaming when parsing the e-mail message.

3. A method as described in claim 2, wherein the indication of media streaming comprises a quality survey request.

4. A method as described in claim 1, further comprising searching for an indication of media rental when parsing the e-mail message.

5. A method as described in claim 4, wherein the indication of media rental comprises a media return confirmation message.

6. A method as described in claim 4, further comprising comparing a transaction value in the e-mail message to distinguish between a media rental event and a media purchase event.

7. A method as described in claim 1, further comprising generating a consumption confidence weight matrix associated with a plurality of merchants and corresponding consumption activity indicators.

8. A method as described in claim 1, further comprising searching the e-mail message for a transaction amount when the indication of consumption activity is absent.

9. A method as described in claim 8, further comprising comparing the transaction amount to a threshold to identify purchase activity or rental activity.

10. A method as described in claim 9, further comprising selecting a confidence weight based on a time of year in response to identifying purchase activity.

11. A method as described in claim 1, wherein the nomenclature associated with media comprises at least one of a movie title, a song title, an artist name, an actor name, an actress name, a documentary title, or an album name.

12. An apparatus to identify media consumption, comprising:
an electronic mail (e-mail) client interface to parse an e-mail message for nomenclature associated with media and, in response to identifying nomenclature associated with media, parse the e-mail message for an indication of consumption activity;
a media nomenclature parsing engine to determine a merchant identity associated with the indication of consumption activity; and
a confidence factor engine to select a consumption confidence weight for the media based on the indication of consumption activity and the merchant identity.

13. An apparatus as described in claim 12, wherein the media nomenclature parsing engine is to search for an indication of media streaming when parsing the e-mail message.

14. An apparatus as described in claim 13, wherein the indication of media streaming comprises a quality survey request.

15. An apparatus as described in claim 12, wherein the media nomenclature parsing engine is to search for an indication of media rental when parsing the e-mail message.

16. An apparatus as described in claim 15, wherein the indication of media rental comprises a media return confirmation message.

17. An apparatus as described in claim 15, further comprising a transaction price comparator to compare a transaction value in the e-mail message to distinguish between a media rental event and a media purchase event.

18. An apparatus as described in claim 12, wherein the confidence factor engine is to generate a consumption confidence weight matrix associated with a plurality of merchants and corresponding consumption activity indicators.

19. An apparatus as described in claim 12, further comprising a transaction price comparator to search the e-mail message for a transaction amount when the indication of consumption activity is absent.

20. An apparatus as described in claim 19, wherein the transaction price comparator is to compare the transaction amount to a threshold to identify purchase activity or rental activity.

21. An article of manufacture comprising a tangible machine readable storage medium storing machine-accessible instructions that, when executed, cause a machine to, at least:
parse an electronic mail (e-mail) message for nomenclature associated with media;
in response to identifying nomenclature associated with media, parse the e-mail message for an indication of consumption activity;
determine a merchant identity associated with the indication of consumption activity; and
select a consumption confidence weight for the media based on the indication of consumption activity and the merchant identity.

22. An article of manufacture as described in claim 21, wherein the machine-accessible instructions, when executed, cause the machine to search for an indication of media streaming when parsing the e-mail message.

23. An article of manufacture as described in claim 21, wherein the machine-accessible instructions, when executed, cause the machine to search for an indication of media rental when parsing the e-mail message.

24. An article of manufacture as described in claim 23, wherein the machine-accessible instructions, when executed, cause the machine to compare a transaction value in the e-mail message to distinguish between a media rental event and a media purchase event.

25. An article of manufacture as described in claim 21, wherein the machine-accessible instructions, when executed, cause the machine to generate a consumption confidence weight matrix associated with a plurality of merchants and corresponding consumption activity indicators.

26. An article of manufacture as described in claim 21, wherein the machine-accessible instructions, when executed, cause the machine to search the e-mail message for a transaction amount when the indication of consumption activity is absent.

27. An article of manufacture as described in claim 26, wherein the machine-accessible instructions, when executed, cause the machine to compare the transaction amount to a threshold to identify purchase activity or rental activity.

28. An article of manufacture as described in claim 27, wherein the machine-accessible instructions, when executed, cause the machine to select a confidence weight based on a time of year in response to identifying purchase activity.
